(19) United States
(12) Patent Application Publication
(10) Pub. No.: US 2005/0129340 A1
(43) Pub. Date: Jun. 16, 2005

(54) Hourglass bearing

(76) Inventor: Robert A. Arnold, Yorba Linda, CA (US)

Correspondence Address: Michaud-Duffy Group LLP, 306 Industrial Park Road Suite 206, Middletown, CT, 06457, US

(21) Appl. No.: 10/732,110

(22) Filed: Dec. 10, 2003

(51) Int. Cl. F16C 23/04

(52) U.S. Cl. 384/192

(57) ABSTRACT

A bearing assembly includes a shaft having a cylindrical bearing surface and a component with an annular portion at one end having a bore with a convex, toroidal inner surface in contact with the bearing surface of the shaft and a predetermined maximum degree of misalignment of the shaft. The bearing assembly is particularly useful for connecting a lever arm to an actuator ring in a variable stator vane system of a gas turbine compressor.

### BACKGROUND OF THE INVENTION

The present invention relates generally to bearing systems for use with shafts, and more particularly to bearing systems which will accommodate a predetermined amount of shaft misalignment.

In a gas turbine engine, pressurized air from a compressor is directed to a combustor where it is ignited, thereby generating hot combustion gases. These gases flow downstream into multiple turbine stages that power the compressor. The compressor contains a variable stator vane system (VSV system) to control the air flow rate therethrough. When an increase in the air flow rate is required, the vanes are rotated to open up and allow more air to pass through. The vanes are closed when a reduction in the air flow rate is required.

VSV systems are designed with rows of vanes called stages. Each stage is controlled so that all the vanes in the stage rotate the same amount or angle. To control rotation, each vane includes a shaft that extends radially outwardly from the engine through the stator case. The outer end of each shaft is connected by a lever arm to an actuator ring which extends around the engine case. When the actuator ring is rotated around the engine, all of the vanes rotate or change by the same amount.

The connection between the lever arm and actuator ring typically includes a spherical plain bearing which includes a pin through a bore in the ball portion of the bearing. The spherical plain bearing accommodates a necessary degree of misalignment of the pin during rotation of the actuator ring while allowing a rigid lever arm to be used. However, there are several drawbacks in the use of a spherical plain bearing to accommodate pin misalignment. The pin tends to vibrate against the ball and cause wear to both the pin and the bore of the ball. Furthermore, the ball is normally made of a metal which increases the weight of the system. Additionally, a spherical plain bearing requires at least two pieces, namely the ball and an outer race. Accordingly, it would be useful to develop an improved bearing which accommodates misalignment of a pin that connects an actuator ring to a lever arm in a VSV system.

It is an object of the present invention to provide a novel bearing for use in conjunction with variable stator vanes in a gas turbine compressor.

It is a further object of the invention to provide a multi-purpose, wear-resistant and lightweight bearing which permits a predetermined amount of shaft misalignment.

Another object is to provide a novel method of designing a bearing for use with a shaft which is subjected to misalignment during use.

Another object is to provide such a bearing having a minimum number of component parts.

Yet another object is to provide a novel toroidal or hour glass bearing and an efficient method for designing such a bearing.

### SUMMARY OF THE INVENTION

It has now been found that the foregoing and related objects may be readily attained in a bearing assembly comprising a shaft having a cylindrical bearing surface, and a cooperating member with an annular portion at one end having a central, longitudinal axis and a convex, toroidal inner surface configured in contact the bearing surface of the shaft and accommodating a predetermined maximum degree of misalignment of the shaft relative to the central axis.

Usually, the toroidal inner surface is provided by a self-lubricating material, which typically comprises resin-impregnated fibers that can be woven, non-woven, knit or braided. The resin typically comprises a thermoplastic material. The shape or curvature of the toroidal inner surface is usually based on a ring torus. The curvature of the toroidal inner wall preferably is determined by the formula:

$$R = 1 / 2 D - \frac{C L}{1 - \frac{1}{cos Θ}}$$

wherein θ is the maximum desired degree of shaft misalignment, D is the diameter of the shaft, CL is the clearance on each side of the shaft, and R is the radius of a circle defining the curvature of the inner wall.

In one embodiment of the invention, the annular component is formed on a lever arm that is configured for connecting a variable stator vane to an actuator ring. In another embodiment, the annular component is fixed to an actuator ring which is configured to actuate a variable stator vane system.

Another form of the invention is a method for designing a toroidal bearing for use around a cylindrical shaft which can accommodate a specified amount of misalignment, comprising the steps of (a) determining the maximum misalignment angle θ, (b) selecting the diameter D of the shaft, (c) determining the necessary amount of clearance CL on each side of the shaft, and (d) determining the radius of curvature R of the toroidal bearing surface using the formula.

$$R = 1 / 2 D - \frac{C L}{1 - \frac{1}{cos Θ}}$$

Another form of the invention is a method of making a bearing component for use in a variable stator vane assembly in a compressor, comprising the steps of (a) providing an actuation system component selected from the group consisting of a lever arm and an actuator ring, and (b) molding a toroidal bearing on the actuation system component. Usually, the bearing has an annular configuration with a convexly, toroidal inner wall. The inner wall typically has an exterior layer of a self-lubricating material. The exterior layer preferably is formed from a sheet or a tube. The molding step typically includes placing the sheet or tube in a mold, and injecting a bearing material into the mold, thereby pressing the sheet or tube into a toroidal shape and bonding the sheet or tube to the bearing material.

Yet another form of the invention is an actuation system for a variable stator vane in a gas turbine compressor. The actuation system comprises a vane shaft which extends outwardly from the vane and has an outer end, and a lever arm which extends generally perpendicularly from the vane shaft. The lever arm has a first end connected to the outer end of the vane shaft, and a second end. A moveable actuator ring is pivotally connected to the second end of the lever arm by mounting means which include pin means extending through the actuator ring and the lever arm in a direction generally parallel to the vane shaft, and toroidal bearing means surrounding the pin means. The toroidal bearing means is configured to allow for a maximum degree of misalignment of the pin means during movement of the actuator ring.

Another form of the invention is a lever arm for use in a variable stator vane assembly comprising a first end configured for connection to a vane shaft, and a second end configured for connection to an actuator ring and having a toroidal bearing formed thereon. Usually, the bearing means is annular and has a convex, toroidal inner wall comprising a self-lubricating material.

A further form of the invention is an actuator ring for use in a variable stator vane assembly comprising frame means and a plurality of annular, toroidal bearings formed on the frame means. The bearings are each configured to receive a cylindrical shaft therethrough.

### BRIEF DESCRIPTION OF THE ATTACHED DRAWINGS

FIG. 1 is a fragmentary side view, partially in section, of a variable stator vane arrangement in the compressor section of a turbine engine;

FIG. 2 is a cross sectional view of a lever arm with a toroidal bearing integrally formed at one end thereof;

FIG. 3 is a top plan view of the lever arm shown in FIG. 2;

FIG. 4 is a schematic diagram showing the relationship between the misalignment angle θ of a cylindrical shaft positioned within a toroidal bearing with the radius R defining the degree of curvature of the toroidal bearing surface;

FIG. 5 is a sectional view of an actuator ring with a square-shaped cross section having a toroidal bearing formed thereon;

FIG. 6 is a sectional view of an actuator ring with an I-shaped cross section and having a toroidal bearing formed thereon;

FIG. 7 is a sectional view of another actuator ring with an I-shaped cross section and having a toroidal bearing formed thereon;

FIG. 8 is a schematic illustration of a transfer molding assembly used to mold a toroidal bearing onto a support; and

FIG. 9 is a sectional view of a lever arm with a toroidal bearing molded thereon in the apparatus shown in FIG. 8.

### DETAILED DESCRIPTION OF THE PREFERRED EMBODIMENT

The present invention derives from the recognition that durability and weight minimization are critical considerations in designing bearing systems, particularly when the bearing systems are to be used in turbine engines for aircraft. By employing toroidal bearings, vibration-induced wear of the bearings can be substantially reduced as compared to spherical bearings. Furthermore, toroidal bearings can be formed as a unitary component as compared to the two component parts required for spherical plain bearings, thereby reducing the weight of the bearing system and, as a result, reducing the weight of the engine.

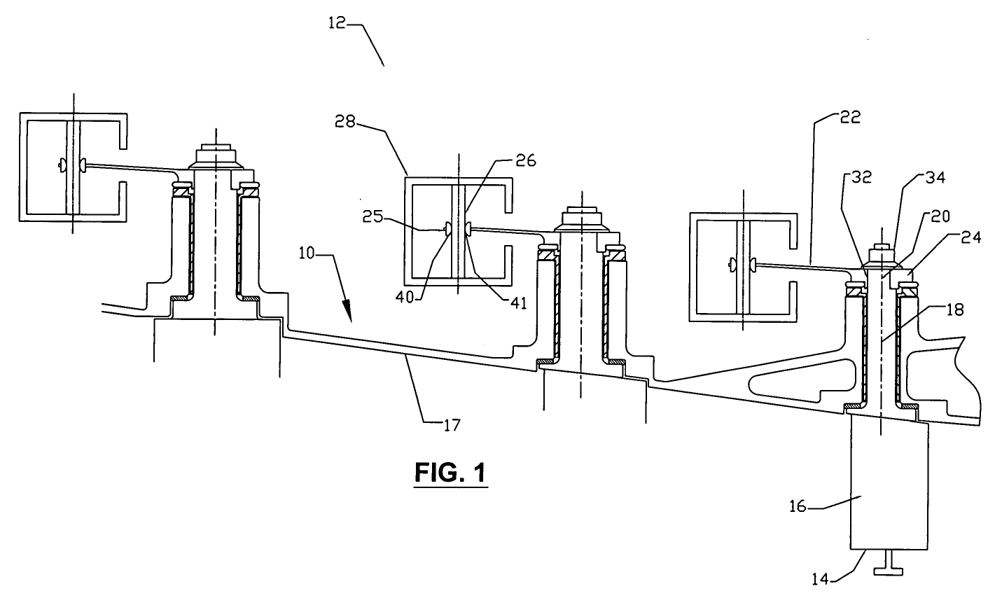

One environment in which the bearing of the invention is particularly useful is in a VSV system of a gas turbine compressor. Turning first to FIG. 1 of the attached drawings, therein illustrated is a gas turbine compressor VSV system in which the compressor is generally designated by the numeral 10. The variable stator vane system, generally designated by the numeral 12 includes a plurality of stator vanes 14, each of which includes a radially inwardly extending blade 16, predominantly positioned within the compressor casing 17, and a radially outwardly extending stem 18 positioned outwardly of the compressor casing 17. The outer end 20 of the stem 18 is connected to a perpendicularly extending lever arm 22 at one end 24. The other end 25 of the lever arm 22 is connected perpendicularly by the pin 26 to an actuator ring 28 that extends circumferentially around the compressor 10 and is attached to a plurality of lever arms (not shown) that are positioned around the circumference of the compressor 10. The air flow rate through the compressor 10 can be controlled by rotating the actuator rings 28 around the circumference of the compressor casing 17, which in turn causes axial rotation of the stator vane blades 16 within the compressor 10.

The lever arm 22 is thin when viewed from the side, and preferably is made of metal. The lever arm 22 has a bore 32 through its one end 24 seating one end of a bolt 34, the other end of which is seated in a threaded bore in the outer end 20 of the stem 18 to hold the lever arm 22 in place. The lever arm 22 rotates around the axis of the bolt 34. The other end 25 of the lever arm 22 has an hourglass-shaped or toroidal bore 40 therein specifically dimensioned to receive the pin 26 and allow for a specific degree of misalignment of the pin 26 relative to the longitudinal axis of the bore. The bore 40 provides a toroidal bearing surface 41 which can be formed of a bearing material with self-lubricating properties, adhering a self-lubricating liner in the bearing body, or applying a durable coating of a self-lubricating material to provide the bearing surface. The bearing configuration, which provides contact between the cylindrical surface of the pin 34 and the toroidal surface of the bearing, permits rotational and axial motion of the pin 34 and correction of misalignment.

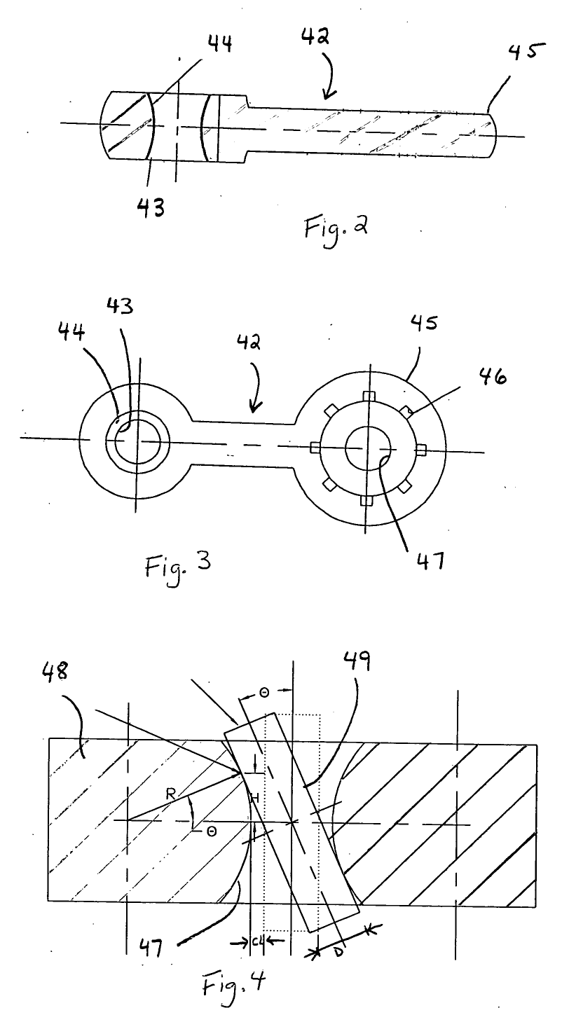

Referring next to FIGS. 2 and 3, another embodiment of a lever arm is shown and is generally designated by the number 42. The lever arm 42 is formed from a composite material and is therefore thicker than the metal lever arm 22 shown in FIG. 1 in order to provide the necessary component strength. The lever arm 42 has an hourglass shaped bore 43 providing a toroidal, self-lubricating bearing surface 44. The one end 45 of the lever arm 42 also has a plurality of rectangular recesses 46 surrounding the round central bore 47. Each of the rectangular recesses 46 is configured to receive a key. The lever arm 42 can be molded as a single piece from a rugged composite material.

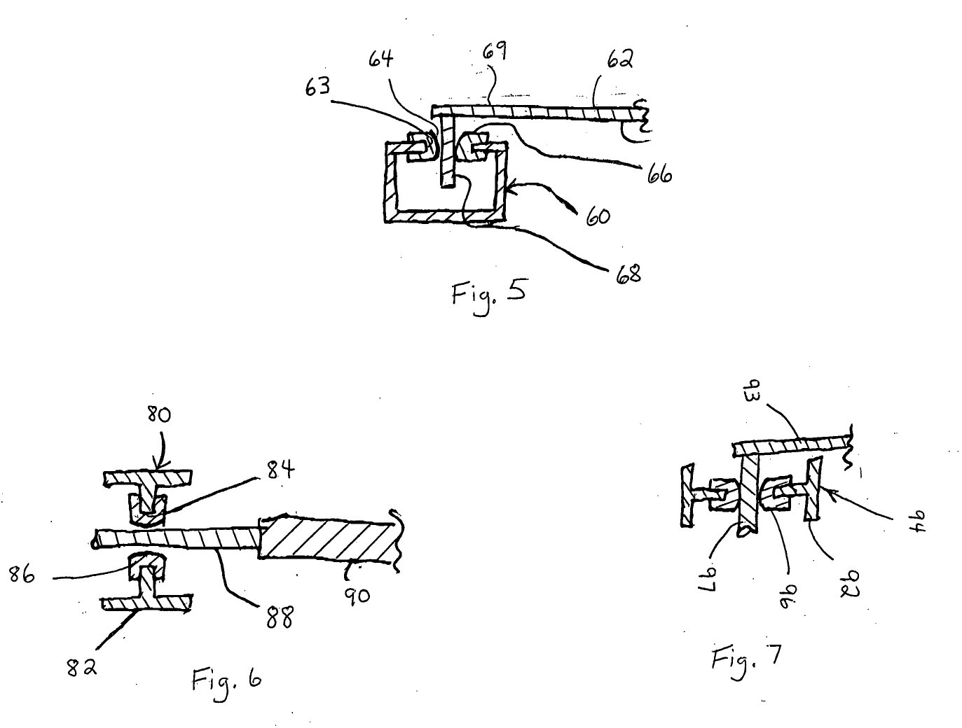

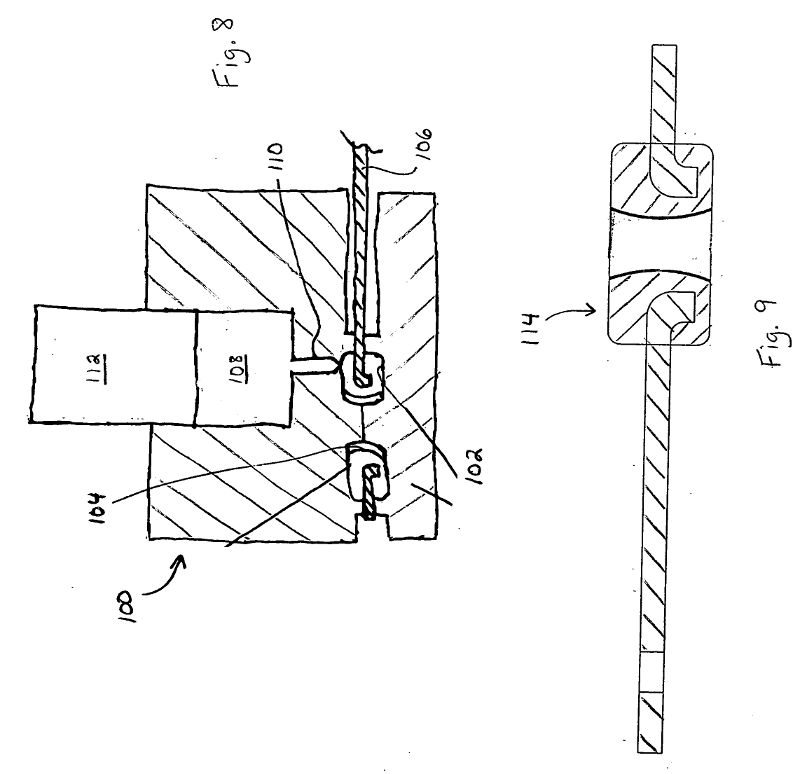

Referring now to FIG. 4, the relationship between the angle of pin misalignment and the curvature of a toroidal bearing based on a ring torus is shown. Generally, the degree of curvature of the toroidal surface 47 of the bearing 48 is selected to accommodate a predetermined amount of misalignment while at the same time minimizing stresses created by the applied load. The toroidal curvature can be based on a ring torus, an elliptical torus, or some other curve geometry. When the curvature of the bearing surface is based on a ring torus, the radius of curvature can be calculated by using a specific geometric derivation. This formula takes into account not only the surface-to-surface stresses involved in a bearing, but also sub-surface conditions of stress that depend upon the shape of the contacting surfaces. The curved, toroidal shape of the bearing supports the load applied by the pin 49. The small curvature of the toroidal surface will result in high sub-surface stresses. As the degree of curvature is increased, the shape of the toroidal surface flattens and sub-surface stresses are reduced. Preferably, the degree of curvature is selected to be as large as possible while accommodating the desired degree of shaft misalignment.

In designing a toroidal bearing for a particular application, the required maximum misalignment angle θ is determined and a shaft diameter D is selected. Furthermore, the necessary clearance CL between each side of the shaft and the bearing is determined, often based upon manufacturing tolerances. In the context of a connection between a lever arm and an actuator ring, the clearance CL typically would be 0.001 inches. The radius R for the ring upon which the toroidal surface is based is then calculated as follows:

$$R = 1 / 2 D - \frac{C L}{1 - \frac{1}{cos Θ}}$$

This value of R will be the maximum radius that will permit the required maximum degree of shaft misalignment.

Referring now to FIG. 5, an alternate embodiment of an actuator ring 60 incorporating a toroidal bearing is shown. The actuator ring 60 is configured to be used in conjunction with a lever arm 62 which does not have a bearing on its other end. The actuator ring 60 has a hollow rectangular cross section with a plurality of openings 63 formed along one side of the rectangle. Each opening 63 has an hourglass-shaped bore 64 provided by a toroidal bearing 66. Each bearing 66 is configured to accommodate a pin 68 which extends through the bore 64 and is perpendicularly attached to the other end 69 of the lever arm 60.

Referring now to FIG. 6, an alternate embodiment of an actuator ring 80 with an hourglass or toroidal bearing uses a beam 82 which extends around the perimeter of a compressor. The beam 82 has an I-shaped cross section with a series of openings 84 in which toroidal bearings 86 are mounted. A pin 88 is positioned in each bearing 86 and is connected to a lever arm 90 in a parallel arrangement. The bearing 86 can be molded directly upon the I-shaped beam 82 or it can be molded to an additional component which is then attached to the I-shaped beam 82.

In FIG. 7, an embodiment is shown in which an I-shaped beam 92 is positioned sideways relative to the lever arm 93 for the actuator ring 94 and a plurality of toroidal bearings 96 are formed thereon in a manner similar to the embodiment shown in FIG. 6. A pin 97 is positioned in each bearing 96.

In addition to actuator rings having square and I-shaped cross sections, other configurations of actuator rings can be used in conjunction with the bearing of the present invention.

One way to form the bearing of the invention is by use of a transfer molding process using simple apparatus, which is shown in FIG. 8. For transfer molding, a mold 100 has a bearing cavity 102 in which a self-lubricating liner material 104 is positioned. A lever arm 106 or other component part which is to support the bearing is partially enclosed in the mold cavity 102. The lever arm typically is made of metal or a sturdy composite. Material for the bearing body, which preferably is a thermoset composition, is placed in a mold pot 108 and is forced through a spine 110 using a plunger 112. The transferred material is then cured at elevated temperature and pressure to form the lever arm bearing assembly 114 shown in FIG. 9. During the curing process, the composite material used to form the bearing body bonds to the liner material. After curing, the plunger 112 is withdrawn, the mold is opened, and the finished lever arm bearing assembly 114 is removed.

As an alternative to transfer molding of a thermoset material, a thermoplastic material can be injection molded to form a bearing on a lever arm or unison ring. This technique is preferred when the bearing body itself is made of a self-lubricating material, thus rendering unnecessary the incorporation of a separate liner component. Furthermore, the lever arm and bearing can be integrally formed as a unitary, non-metallic component using a suitable molding technique.

In the transfer molding process shown in FIG. 8, the self-lubricating liner 104 typically is formed from a polytetrafluoroethylene (PTFE) impregnated fabric, and more particularly is a woven, non-woven, knitted or braided fabric impregnated with PTFE. The fabric material may be saturated with a resin before or during the molding process. In either case, the liner material starts out as a flat piece of essentially two-dimensional material that is formed into a toroidal shape during molding. Alternatively, if the fabric is produced as a knit tube in a cylindrical shape, a cut piece of tube is then formed into a toroidal shape during molding. Preferably, the liner is a woven fiber impregnated with PTFE.

Thus, it can be seen that the bearing assembly of the present invention provides an overall weight reduction of the compressor combined with good wear resistance, and accommodates a predetermined amount of shaft misalignment.

1. A bearing assembly comprising:
a shaft having a cylindrical bearing surface, and
a cooperating component having a generally annular end portion with a central axis, a convexly toroidal inner surface in contact with the bearing surface of said shaft, accommodating a predetermined maximum degree of misalignment of said shaft relative to said central axis.

2. The bearing assembly in accordance with claim 1, wherein said inner surface of said annular end portion is provided by a self-lubricating material.

3. The bearing assembly in accordance with claim 2, wherein said self-lubricating material comprises resin-impregnated fibrous material.

4. The bearing assembly in accordance with claim 3, wherein said resin comprises a thermoplastic material.

5. The bearing assembly in accordance with claim 1, wherein said toroidal inner wall surface has a shape which is based on a ring torus.

6. The bearing assembly in accordance with claim 1 wherein the curvature of said inner wall is determined by the formula
$$R = 1 / 2 D - \frac{C L}{1 - \frac{1}{cos Θ}}$$
wherein θ is said maximum degree of misalignment, D is the diameter of said shaft, CL is the clearance on each side of said shaft, and R is the radius of a circle defining said curvature of said inner wall.

7. The bearing assembly in accordance with claim 1, wherein said annular end portion is formed on a lever arm for connecting a variable stator vane to an actuator ring.

8. The bearing assembly in accordance with claim 1, wherein said annular component is fixed to an actuator ring which is configured to actuate a variable stator vane system.

9. A method of designing a toroidal bearing for seating a cylindrical shaft therein and accommodated a specified amount of misalignment, comprising the steps of:
(a) determining the maximum misalignment angle θ;
(b) selecting the diameter D of the shaft;
(c) determining the necessary amount of clearance CL on each side of the shaft; and
(d) determining the radius of curvature R of the toroidal bearing using the formula
$$R = 1 / 2 D - \frac{C L}{1 - \frac{1}{cos Θ}}$$

10. The method in accordance with claim 9, wherein CL is 0.001 inches.

11. A method of making a bearing assembly for use in a variable stator vane assembly in a compressor, comprising the steps of:
(a) providing an actuation system component selected from the group consisting of a lever arm and an actuator ring, and
(b) molding a bearing about one end of said actuation system component, said bearing having a toroidal passage therethrough; and
(c) inserting a shaft into said toroidal passage.

12. A method of making a bearing assembly in accordance with claim 11 wherein said bearing has an annular configuration with a convexly, toroidal inner wall.

13. The method of making a bearing component in accordance with claim 11, wherein said inner wall is provided by a surface layer of a self-lubricating material.

14. The method of making a bearing assembly in accordance with claim 13 wherein said surface layer is formed from a preformed sheet or tube.

15. The method of making a bearing assembly in accordance with claim 14 wherein step (b) includes:
(i) placing said sheet or tube in a mold, and
(ii) injecting a bearing material into said mold, to press said sheet or tube into a toroidal shape and bond said sheet or tube to said bearing material.

16. An actuation system for a variable stator vane in a gas turbine compressor, the actuation system comprising:
(a) a shaft extending outwardly from the vane and having an outer end;
(b) a lever arm extending generally perpendicularly to said shaft, said lever arm having a first end connected to said outer end of said shaft and a second end;
(c) a movable actuator ring pivotally connected to said second end of said lever arm; and
(d) mounting means connecting said actuator ring to said lever arm, said mounting means including pin means extending through said actuator ring and said lever arm in a direction generally parallel to said shaft, and toroidal bearing means surrounding said pin means and being configured to allow for a maximum degree of misalignment of said pin means during movement of said actuator ring.

17. The actuation system in accordance with claim 16 wherein said bearing means is annular and has a convex, toroidal inner wall.

18. The actuation system in accordance with claim 17 wherein said inner wall is provided by a self-lubricating material.

19. The actuation system in accordance with claim 18 wherein said self-lubricating material comprises resin-impregnated fibers.

20. The actuation system in accordance with claim 19 wherein said resin comprises a thermoplastic material.
